(19) United States
(12) Patent Application Publication
(10) Pub. No.: US 2014/0122421 A1
(43) Pub. Date: May 1, 2014

(54) INFORMATION PROCESSING APPARATUS, INFORMATION PROCESSING METHOD AND COMPUTER-READABLE STORAGE MEDIUM

(71) Applicant: FUJITSU LIMITED, Kawasaki-shi (JP)

(72) Inventor: MASANOBU FURUKOSHI, Kawasaki (JP)

(73) Assignee: FUJITSU LIMITED, Kawasaki-shi (JP)

(21) Appl. No.: 14/147,661

(22) Filed: Jan. 6, 2014

Related U.S. Application Data
(63) Continuation of application No. PCT/JP2011/065666, filed on Jul. 8, 2011.

(51) Int. Cl. G06F 17/30

(52) U.S. Cl. CPC G06F 17/30368
USPC 707/609

(57) ABSTRACT

An information processing device provided with: an information processor; a unit for detecting a reset of the information processor; an acquisition unit for acquiring log information from the information processor; at least two buffers for storing the log information acquired by the acquisition means; and a controller for switching the storage destination of the log information acquired by the acquisition means between the at least two buffers, before or after the reset is detected, when a condition has been satisfied in which a predetermined minimum amount or more of log information is not acquired.

### CROSS-REFERENCE TO RELATED APPLICATION

This application is a continuation application of International Application PCT/JP2011/065666 filed on Jul. 8, 2011 and designated the U.S., the entire contents of which are incorporated herein by reference.

### BACKGROUND

The present invention relates to a process of logs of an information processing apparatus.

A system console of a computer is a text output apparatus connected via, e.g., a serial port to the computer. The system console is simply referred to as a console. The computer outputs a message for system management to the console. The message for the system management is called a console log. The console log contains a message given when starting up the computer, messages issued from an OS (Operating System) due to a variety of factors after starting up the OS, messages given from application programs, etc. Namely, the console log contains results of normal operations, e.g., a message in loading or shutting down the OS, a fault message that is output by the OS or Basic Input/Output System (BIOS) when a fault occurs in the computer, and so on.

The OS, after being loaded, collects system logs that are output corresponding to statuses of the computer. In such a scene that a takeover or handover process occurs between the OS and the BIOS as when loading or shutting down the OS, however, there are output messages, which cannot be collected as the system logs by the OS. Even these messages not being collected as the system logs are output to console logs. The console logs are therefore useful in terms of system management.

### DOCUMENTS OF PRIOR ARTS

### Patent Documents

[Patent Document 1] Japanese Patent Application Laid-Open Publication No. 2005-292932
[Patent Document 2] Japanese Patent Application Laid-Open Publication No. H09-6651
[Patent Document 3] Japanese Patent Application Laid-Open Publication No. H11-31091

### SUMMARY

One aspect of the technology of the disclosure can be exemplified by an information processing apparatus that is given as follows. The information processing apparatus includes: an information processing unit; a unit to detect that the information processing unit is reset; an acquiring unit to acquire log information of the information processing unit; a plurality of buffers to get stored with the log information acquired by the acquiring unit; and a control unit to change over the buffer becoming a storage destination of the log information acquired by the acquiring unit when a relation of a time point of resetting the information processing unit and an acquired quantity of the log information satisfies a condition.

The object and advantages of the invention will be realized and

attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating a configuration of an information processing apparatus according to an example 1;

FIG. 2 is a diagram illustrating a configuration of an IPMC;

FIG. 3 is a diagram illustrating a configuration of a WDT;

FIG. 4 is a diagram illustrating a detailed configuration of a console data receiving unit;

FIG. 5 is a flowchart illustrating a processing flow when executing a server stop process;

FIG. 6 is a flowchart illustrating a processing flow when starting up a server;

FIG. 7 is a flowchart illustrating a processing flow for the WDT to detect occurrence of abnormality in a program;

FIG. 8 is a diagram illustrating a comparison between a sequence of a normal operation and a sequence in a case where abnormality occurs when being shut down;

FIG. 9 is a diagram illustrating sequences after the resetting due to startup of the information processing apparatus;

FIG. 10 is a diagram illustrating a sequence in a case where a WDT detects a freezing status of the OS or the application;

FIG. 11 is a flowchart illustrating a processing flow of a control unit of the IPMC;

FIG. 12 is a flowchart illustrating the processing flow of the control unit of the IPMC;

FIG. 13 is a diagram illustrating a configuration of the IPMC according to an example 2;

FIG. 14 is a diagram illustrating a configuration of a console data receiving unit according to the example 2;

FIG. 15 is a diagram illustrating a comparison between the sequence of the normal operation and the sequence in the case where the abnormality occurs when being shut down;

FIG. 16 is a diagram illustrating a comparison between the sequence of the normal operation and the sequence in the case where the abnormality occurs when being started up.

### DETAILED DESCRIPTION

An information processing apparatus according to an aspect of an embodiment will hereinafter be described with reference to the drawings. A configuration of the following embodiment is an exemplification, and the present information processing apparatus is not limited to the configuration of the embodiment.

Console logs are output as character data to, e.g., a serial console port on a chipset. The console logs being output are buffered and thus retained on an output buffer. However, a buffer size for the console logs is finite. Accordingly, when the console logs are accumulated up to a limit of the buffer capacity, for instance, the oldest data is overwritten by newer data.

If a fault is actually caused, however, a message indicating a state of occurrence of the fault is overwritten due to the following factors, and the console logs cannot be used as the case may be. Note that the console log containing the message indicating the state of occurrence of the fault is to be called a fault log. Further, the following factors can arise when acquiring, without being limited to the console logs, logs of a computer system with a capacity of the log storage destination being finite.

(a) It may happen that a large quantity of messages are output by applications other than the OS.
(b) It may happen that the computer is restarted by a user's operation and by a system operation, and a message generated when restarted is output, as result of which the fault log on the buffer is overwritten.
(c) A long period of time elapses till extracting the fault log from the buffer depending on an operating condition of the computer. As a result, it may happen that before an administrator of the computer system or a computer program for analyzing the fault extracts the fault log, the operations (a) and (b) are repeated, and the fault log is overwritten.

On the other hand, there exists a console log saving method such as connecting a console server for accumulating the logs, or alternatively accumulating the logs in another server by use of a SOL (Serial Over LAN) function for transferring the console data to another server. The console server or the SOL involves an increase in maintenance cost because of introducing dedicated equipment itself. Further, even if introducing the console server or the SOL, a majority of acquired logs are useless when in a normal operation in many cases. Accordingly, there are a small number of users who prepare the dedicated equipment such as the console server or the SOL. Moreover, the fault log is accumulated in separation from the computer system where the fault occurs, and hence a mechanism for associating the computer undergoing the occurrence of the fault with the fault log is required. Moreover, an operation of specifying a message generated when the fault occurs from a mass amount of logs acquired by the dedicated equipment such as the console server or the SOL, involves a difficulty as the case may be.

What summarizes the problems described above is given as follows.

(1) When the fault occurs, the message related to the fault is output to the log such as the console log from the computer system. The message related to the fault might, however, disappear as the case may be because of outputting other messages generated when the user performs operations of starting up and shutting down the computer system and when a system operation works for a recovery from the fault, and so on.
(2) If provided with the dedicated equipment for accumulating the logs, the cost rises.
(3) It is difficult to distinguish between the log generated when the fault occurs and other messages. Especially, the computer system of nowadays includes apparatuses of a plurality of vendors or a plurality of computer programs. Then, there are a great variety of fault messages that are output by OSs, BIOSs and other compute programs developed by the different vendors. Such a case also exist that it is difficult to specify and extract the log generated when the fault occurs from these multiple messages of the computer system.

### First Working Example

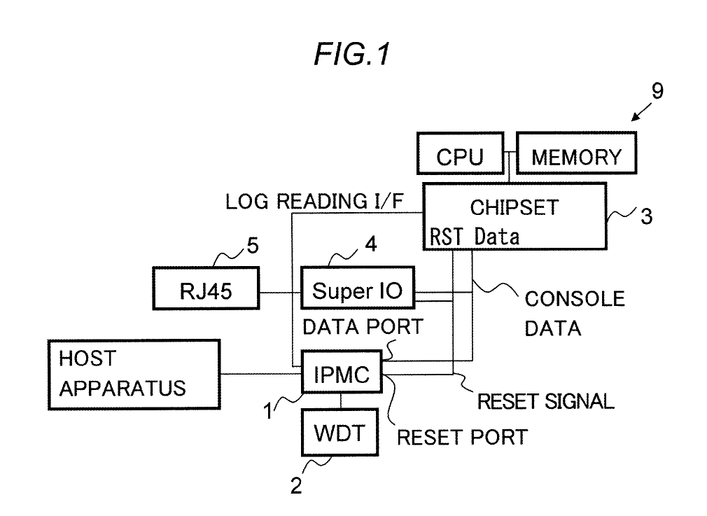

An information processing apparatus 9 according to a first working example (Example 1) will be described with reference to the drawings in FIGS. 1 through 10. FIG. 1 is a diagram illustrating a configuration of the information processing apparatus 9 according to the example 1. The information processing apparatus 9 is a computer called, e.g., a server that provides an information processing function. Further, the information processing apparatus 9 may be a computer system including a plurality of computers. Still further, the information processing apparatus 9 may also be a computer called, e.g., a blade server, which is one of the computers included in the computer system. Yet further, the information processing apparatus 9 is, if being the apparatus that outputs console logs, available regardless of its type. For example, the information processing apparatus 9 may also be a personal computer.

As in FIG. 1, the information processing apparatus 9 includes a Central Processing Unit (CPU), a memory, a chipset 3, an I/O chip 4 that receives data of console logs from the chipset 3, a connector (RJ45 connector) 5 to which the data of the console logs are output from a serial console port of the I/O chip 4, an Intelligent Platform Management Controller (IPMC) 1 that receives the data of the console logs from the chipset 3 and a Watchdog Timer (WDT) 2. The IPMC 1 is a microcontroller that manages operations of hardware or firmware of the computer such as the server blade.

The chipset 3 executes a process related to transferring and receiving the data between the respective units such as the CPU and the memory. The chipset 3 includes, e.g., an input/output controller etc. The chipset 3 is exemplified by, e.g., an Intel Architecture (IA) chipset. It does not, however, mean that the chipset 3 of the information processing apparatus 9 is limited to the IA chipset. Namely, if being a configuration capable of providing the function as the information processing apparatus 9, any types of chipsets may be available. The chipset 3 may be a chipset including architecture of, e.g., a SPARC (Scalable Processor ARChitecutre) chip. Moreover, the chipset 3 may also be a chipset including a processor for being built-in a device. Each of the chipset 3, the CPU, the memory, etc is one example of an information processing unit.

The example in FIG. 1 is that the chipset 3 outputs the data of the console logs and a reset signal to the I/O chip 4 and the IPMC 1. The data of the console logs are data containing messages output from an OS, a BIOS, middleware, application programs, etc on the CPU. The reset signal is a signal used for a reset circuit included in the chipset 3 to reset the CPU. The reset signal is issued when starting up the CPU, thereby setting the hardware of the CPU in an initial status. The CPU starts processing after being initialized by the reset signal and executes starting up the BIOS, booting the OS, and so on.

The I/O chip 4 receives the data of the console logs from the chipset 3, and outputs the received data to the RJ45 connector 5 from the serial console port. The I/O chip 4 is exemplified by a chip called a Super I/O chip. The Super I/O chip is an I/O interface configured to combine a variety of serial interface, a variety of parallel interface, interfaces with various types of devices, etc. It does not, however, mean that the I/O chip 4 is limited to the Super I/O chip in the information processing apparatus 9. Likewise, it does not mean that output paths of the console logs are limited to the I/O chip 4 and the RJ45 connector 5. For example, whatever configurations may be available if having specifications enabling text information to be output from the serial port.

The IPMC 1 is a microcontroller that manages the operations of the hardware and the firmware of the information processing apparatus 9, e.g., the blade server. The IPMC 1 receives the data of the console logs from the chipset 3 and executes a process of saving the received data. The IPMC 1 has a data port (Data) for receiving the data of the console logs and a reset port (RST) for receiving the reset signal. In the example of FIG. 1, the I/O chip 4 and the IPMC 1 are connected in parallel to the chipset 3. It does not, however, mean that the configuration of the information processing apparatus 9 is limited to the configuration in FIG. 1. For instance, the I/O chip 4 and the IPMC 1 may be connected in series to the chipset 3. For example, the IPMC 1 may receive the data of the console logs from the serial port of the I/O chip 4. Conversely, the IPMC 1 may hand over the data of the console logs to the I/O chip 4.

The WDT 2 periodically receives an unillustrated timer initialization signal from the chipset 3 and is thereby initialized. Then, the WDT 2, when disabled from receiving the timer initialization signal for a predetermined period of time, sends a notification signal to the IPMC 1.

Further, in FIG. 1, the information processing apparatus 9 is connected to a host apparatus. The host apparatus is, e.g., a management-oriented computer that manages the information processing apparatus 9 and other information processing apparatuses. The information processing apparatus 9 is connected to the host apparatus via a communication interface such as Network Interface Card (NIC), Fibre Channel and InfiniBand.

Note that the information processing apparatus 9 may include an external storage device such as a hard disk drive. Moreover, the information processing apparatus 9 may also include a drive for a detachable storage medium such as a CD (Compact Disc), a DVD (Digital Versatile Disc), a Blu-ray disc and a flash memory card.

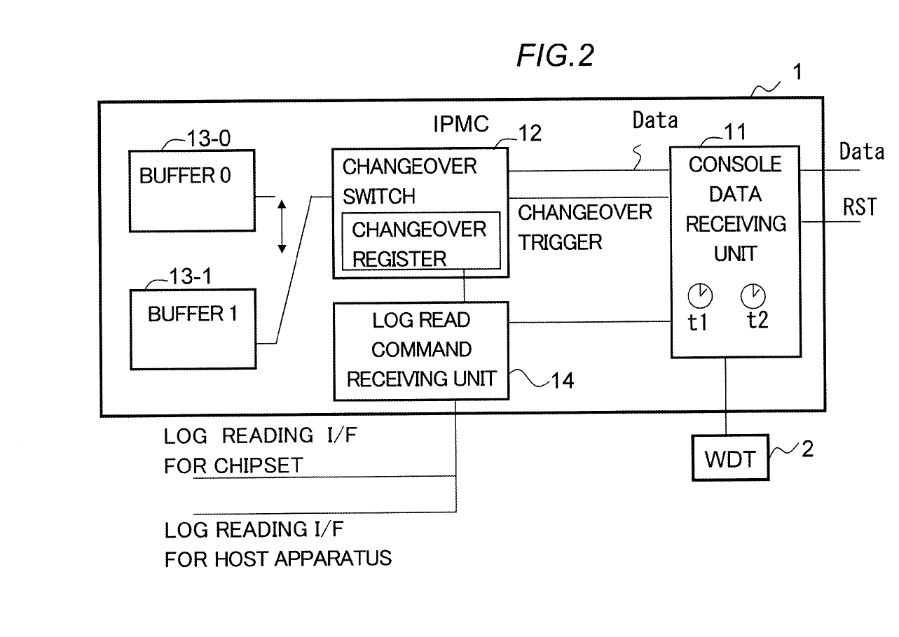

FIG. 2 illustrates a configuration of the IPMC 1. The IPMC 1 includes a console data receiving unit 11, a changeover switch 12, buffers 13-0, 13-1 and a log read command receiving unit 14.

The console data receiving unit 11 receives the data of the console logs from the chipset 3, and saves the received data in the buffer 13-0 or 13-1 via the changeover switch 12. The console data receiving unit 11 monitors if the data port (Data) of the IPMC 1 receives the data of the console logs, and acquires the received data. The console data receiving unit 11 also monitors if the reset port receives the reset signal (RST). Herein, the reset signal indicates that the processor is initialized when the information processing apparatus 9 is started up.

Further, the console data receiving unit 11 includes a timer 113, which counts a period of time during which the console logs are received, a period of time during which the console logs are not received, a period of time till the reset signal is generated after confirming that the console logs are not received, or a period of time after receiving the reset signal. Then, the console data receiving unit 11 controls the changeover switch 12, e.g., when the console logs are not acquired for a predetermined period of time, thereby changing over a data storage destination of the console logs between the buffer 13-0 and the buffer 13-1.

To be specific, the console data receiving unit 11 monitors a status of receiving the data of the console logs, and, if there occurs an event that the data reception is stopped or an event that a fluctuation of a data size of the console logs is stopped, such an event triggers a start of counting time t1, t2, . . . by the timer 113. The event that the data reception is stopped or that the fluctuation of the received data size is stopped, etc will hereinafter be simply referred to as “the stop of the data fluctuation”.

The time t1 is time to be counted for making a confirmative determination of the stop of the data fluctuation and is used for determining whether or not the data fluctuation stops in excess of a presetting-enabled threshold value (which will hereinafter be termed first predetermined time T1). The time t2 is time to be counted till resetting occurs. A count of the time t2 may be started after confirming, e.g., the stop of the data fluctuation. Then, the time t2 is used for determining whether or not the resetting occurs within the presetting-enabled threshold value (which will hereinafter be termed second predetermined time T2) after the stop of the data fluctuation.

Furthermore, a trigger signal is inputted to the console data receiving unit 11 from a Watchdog Timer (which will hereinafter be abbreviated to WDT 2). The WDT 2 is a timer for detecting, e.g., that the OS or the application becomes abnormal with the result that the computer gets into a freezing status.

The WDT 2 is provided as one of the functions of, e.g., Intelligent Platform Management Interface (IPMI). The IPMI is defined as a standard interface specification for enabling the hardware of the server or the network devices to be monitored. It does not, however, mean that the WDT 2 is limited to the IPMI specification-based timer. The WDT 2 is one example of a trigger signal generating unit.

The log read command receiving unit 14 is connected to the chipset 3 or the host apparatus of the information processing apparatus 9. The log read command receiving unit 14, upon receiving a log read command from the CPU of the chipset 3 or from the host apparatus of the information processing apparatus 9, transmits the console logs of the buffer 13-0 or the buffer 13-1 back to a log read command sender.

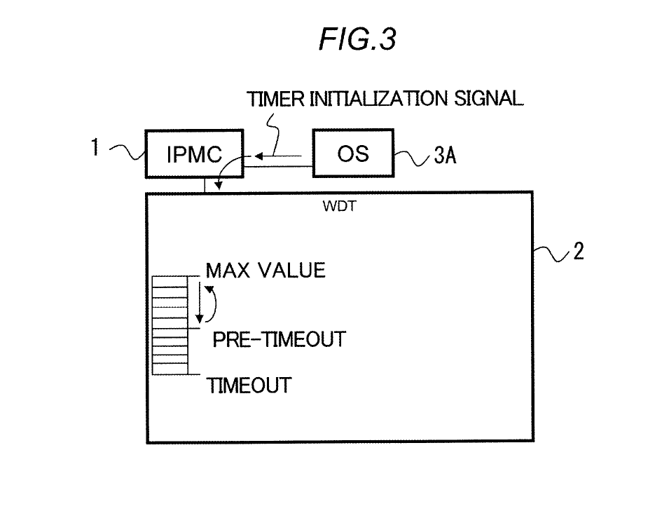

FIG. 3 illustrates a configuration of the WDT 2. The WDT 2 has a counter that subtracts a value from a MAX value at an interval of a predetermined period. The WDT 2 receives a timer initialization signal from an OS 3A on the CPU via the IPMC 1 and the chipset 3, and sets the counter (counter value) to the MAX value. Then, the WDT 2 repeats the subtraction of the counter value till receiving the next timer initialization signal. Subsequently, when the counter value reaches a pre-timeout value, the WDT 2 supplies the pre-timeout signal to the IPMC 1. In the example 1, the pre-timeout signal is employed for detecting, e.g., a freeze of the information processing apparatus 9, the OS or the application. The pre-timeout value is one example of a predetermined period, and the pre-timeout signal is one example of a trigger signal.

For example, a malfunction occurs in the OS or the application with the result that the information processing apparatus 9 gets frozen, and the timer initialization signal stops being supplied to the WDT 2. Thereupon, the subtraction of the counter continues, and the counter value comes to a pre-timeout status and further to a timeout status. When coming to the timeout status, a timeout signal is output to the IPMC 1, and the IPMC 1 detects occurrence of the malfunction in the OS or the application. On the other hand, the subtraction of the counter value is repeatedly executed, during which the WDT 2, upon receiving the next timer initialization signal, sets again the counter value to the MAX value.

A usage example of the WDT 2 is exemplified by giving notification of the occurrence of malfunction in the monitoring target component with an interrupt to the OS as caused by, e.g., the pre-timeout. Further, the usage example of the WDT 2 is also exemplified by starting up a recovery process for the monitoring component with a resetting operation etc as caused by the timeout. The counter MAX value, the pre-timeout value, the timeout value and the occurrence period of the timer initialization signal by the OS can be set from outside.

The console data receiving unit 11 is controlled by the operations of the computer program, the firmware, etc executed by the CPU of the IPMC 1. An operation that the CPU, functioning as the console data receiving unit 11, of the IPMC 1 executes the processes according to the computer program, the firmware, etc will hereinafter be said such that the log read command receiving unit 14 executes the processes. However, the console data receiving unit 11 may be a data receiving circuit of the console logs and may also be a dedicated digital circuit including the timer 113.

The changeover switch 12 includes a changeover register containing a register bit, which is synchronized with a connecting destination of the changeover switch 12, and can control the connecting destination of the changeover switch 12 itself by rewriting the register bit. For example, when the register bit=“0”, the console data receiving unit 11 is connected to the buffer 13-0. Further, when the register bit=“1, the console data receiving unit 11 is connected to the buffer 13-1. The changeover switch 12 may be a switch configured softwarewise as a computer program and may also be a switch configured hardwarewise. The switch as the computer program can be exemplified by a processing module that determines the bits set in, e.g., the memory, the register, etc and changes over an output destination of the console logs between the buffer 13-0 and the buffer 13-1. Moreover, the hardware switch can be exemplified by the digital circuit that changes over the connecting destination in a way that corresponds to the register bit or by a circuit including a transistor etc. The buffers 13-0, 13-1 are defined as, e.g., areas on the memory of the IPMC 1. It does not, however, mean that the number of buffers is limited to “2”.

To be more specific, the console data receiving unit 11 executes the following processes by use of the changeover switch 12 and the buffers 13-0, 13-1.

(1) The console data receiving unit 11 saves the data of the console logs by changing over the buffers 13-0 and 13-1 through the changeover switch 12. In the normal console log, data for one screen is given such as 80 characters×25 rows=2048 B. In the example 1, it is assumed that each of the buffers 13-0, 13-1 has a capacity for the data larger than one screen of the console log. For instance, each of the buffers 13-0, 13-1 is assumed to be 65536 (64 KB=32 screens).

(2) The console data receiving unit 11 sets, e.g., the buffer 13-0 as an initial console log storage area. Accordingly, in a normal operation status of the information processing apparatus 9, it is assumed that the console data continues to be recorded on the buffer 13-0.

(3) It is assumed that the buffers 13-0, 13-1 record the received console data sequentially from an initial address and, when a recorded data size reaches a limit of the buffer capacity, overwrites the data over the already recorded data by returning to the initial address.

(4) The changeover switch 12 changes over the connecting destination of the console data receiving unit 11, i.e., the CPU of the IPMC 1 between the buffers 13-0 and 13-1. The changeover switch 12 may, however, change over three or more buffers.

(5) Based on the configurations described above as the premise, the console data receiving unit 11 has the following functions.

(a) The console data receiving unit 11 detects whether the data are received or not and whether the received data fluctuate or not. Then, the console data receiving unit 11 detects that the data are not received for a fixed period of time or that the received data do not fluctuate. Herein, an implication that the received data do not fluctuate is that the received data having, e.g., a value “0” or “1” are continuously received.

(b) The console data receiving unit 11 detects occurrence of the reset signal that is issued when restarting up the information processing apparatus 9.

(c) The console data receiving unit 11, if detecting the reset signal (b) within a predetermined period of time since the occurrence of (a), namely detecting that the data are not received for a fixed period of time or that the received data do not fluctuate, gives a changeover trigger of the changeover switch 12. More specifically, the console data receiving unit 11 inverts, e.g., the register bit of the changeover register of the changeover switch 12.

(d) In the case of receiving the pre-timeout signal due to the pre-timeout in the WDT 2, the console data receiving unit 11 gives the changeover trigger of the changeover switch 12.

(6) The changeover switch 12 changes over the connecting destination between the buffer 13-0 and the buffer 13-1 on the basis of the register bit set in the function (3).

(7) In the example 1, the IPMC 1 has another port for reading the console data logs stored therein, and the stored logs can be read from the OS or the host apparatus.

(8) In the example 1, other than the trigger described above, the changeover of the buffer can be executed even by updating the register bit in a way that receives a dedicated command for the IPMC 1 from the OS or the host apparatus.

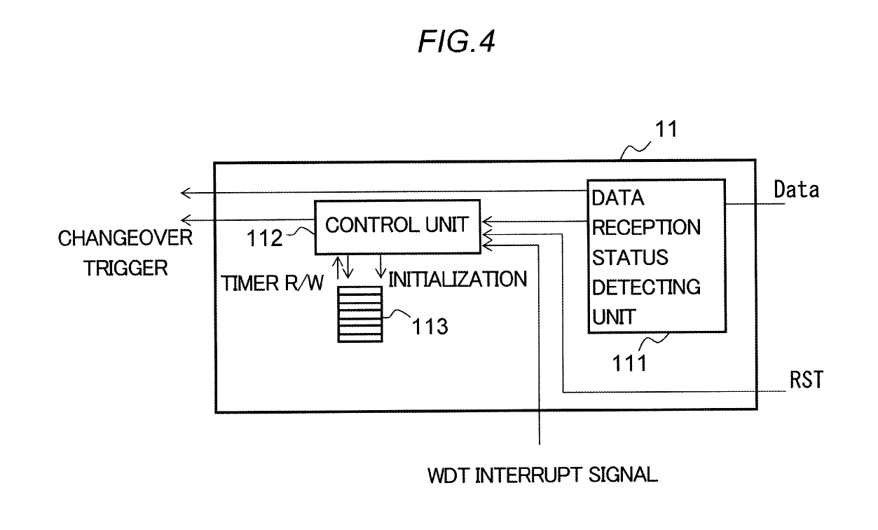

FIG. 4 illustrates a detailed configuration of the console data receiving unit 11. The console data receiving unit 11 includes a data reception status detecting unit 111, a control unit 112 and the timer 113. The data reception status detecting unit 111 monitors the data of the console logs received via a data port of the IPMC 1, and detects whether the data are received or not and whether the received data fluctuate or not. Then, the data reception status detecting unit 111 stores the received data of the console logs in the buffers 13-0, 13-1 as they are via the changeover switch 12. Furthermore, the data reception status detecting unit 111 notifies the control unit 112 of whether the data are received or not and whether the received data fluctuate or not. The data reception status detecting unit 111 is one example of an acquiring unit to acquire log information.

The control unit 112 receives the notification of whether the data are received or not and whether the received data fluctuate or not (reception status signal) from the data reception status detecting unit 111. Moreover, the control unit 112 accepts the reset signal from the chipset 3. Then, the control unit 112 determines a relationship between the reception status signal and the reset signal, and decides a changeover timing of the buffers 13-0, 13-1. The control unit 112 is one example of a unit to detect that the information processing unit is reset and is also one example of an acquiring unit to acquire the log information.

Namely, the control unit 112 starts up, based on the reception status signal, the timer 113 in the case of the occurrence of (a), i.e., if the data are not received or if the received data do not fluctuate during the first predetermined time T1. The first predetermined time T1 is one example of a period during which the log information is not output. Herein, the case that the log information is not output may also be a case where, e.g., the received data size is “0”, i.e., there are none of the received data. Moreover, the case that the log information is not output may be a case where the value of the received data is equal to or smaller than a specified value. Further, the case that the log information is not output may also be a case where the received data do not fluctuate. Still further, the case that the log information is not output may also be a case where a magnitude of the fluctuation of the received data is equal to or smaller than a specified value. A definition of “the magnitude of the fluctuation of the received data is equal to or smaller than the specified value” is that a fluctuation bit count per short period of time is equal to or smaller than the specified value.

Then, if detecting the reset signal issued when restarting up the server within the second predetermined time T2 since the occurrence of (a), the control unit 112 supplies the changeover trigger to the changeover switch 12. The changeover trigger operates to invert the register bit synchronizing with the connecting destination of the changeover switch 12. As a result, the changeover switch 12 establishes the connection, corresponding to the changeover trigger, between the console data receiving unit 11 and the buffer 13-0 or between the console data receiving unit 11 and the buffer 13-1.

After an elapse of the first predetermined time T1, however, if the second predetermined time T2 further elapses, the processes of (a) and (b) are again iterated. Further, if the console logs are received in the course of these processes, the processes of (a) and (b) are stopped, and the operation returns to a normal status.

With the configuration described above, after confirming that the data are not received from the chipset 3 or that the data fluctuation does not occur during the first predetermined time T1, the control unit 112, when the reset signal is inputted within the second predetermined time T2, changes over the changeover switch 12. For example, the changeover switch 12 changes over the connecting destination of the console data receiving unit 11 to the buffer 13-1 from the buffer 13-0. The changeover described above enables the console logs before and after the occurrence of the abnormality to be saved.

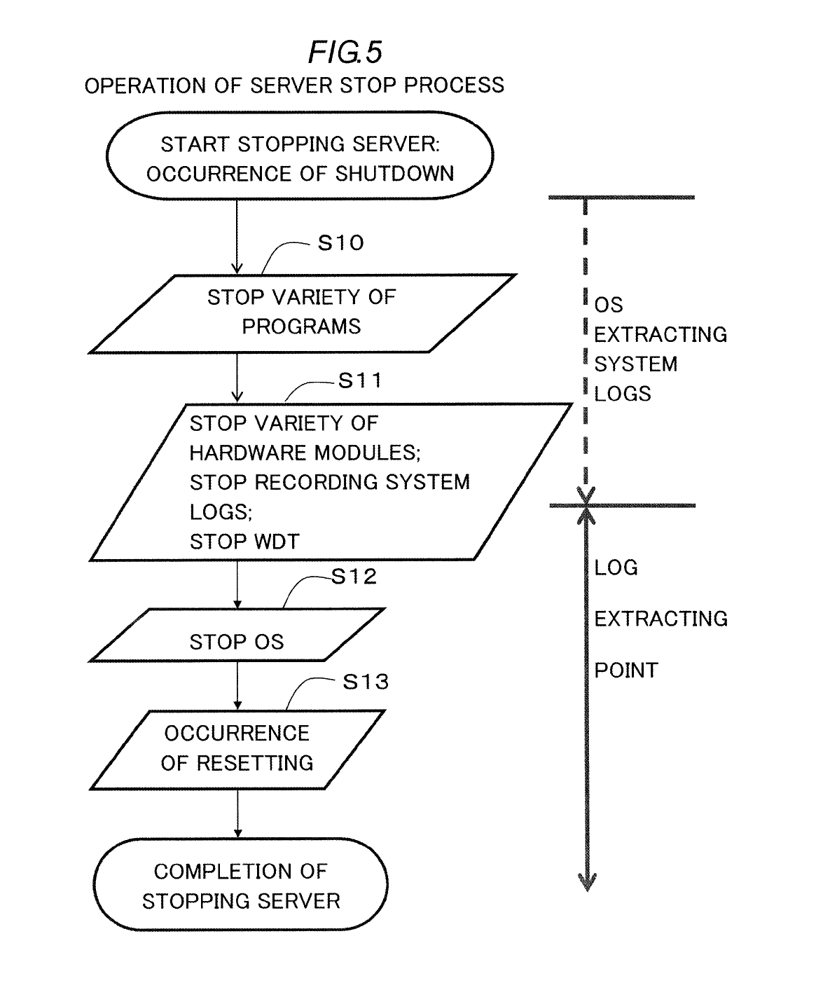

FIG. 5 illustrates a processing flow when executing a server stopping process. A start of the processes is triggered by a user's inputting a shutdown command. A variety of computer programs are stopped by inputting the shutdown command (S10).

Next, a variety of hardware modules of peripheral devices etc and drivers etc for driving the hardware modules are stopped (S11). Note that in the course of the process in step S11, the OS stops acquiring and saving the system logs. Further, the WDT 2 also stops. Next, the OS stops (S12). In this process, from the input of the shutdown command onward, the console logs are acquired for a predetermined period of time, or a predetermined quantity of console logs are acquired, and the OS stops.

In the process of S11, however, what becomes a problem is such a case that the abnormal status occurs in the information processing apparatus 9 after the system logs of the OS have not been saved. In this case, before the stop of the OS, the reception of the console logs is interrupted. Such being the case, the user resets the information processing apparatus 9 by use of, e.g., an external switch etc (S13). Alternatively, the information processing apparatus 9 is commanded to be reset by an exceptional process etc of the information processing apparatus 9. As a result, the information processing apparatus 9 is reset, and, after being restarted, the information processing apparatus 9 stops by executing again the shutdown command.

Before the occurrence of the abnormality, the console logs when being shut down are accumulated in the buffer 13-0 up to the occurrence of the abnormality. Then, with the occurrence of the abnormality, the reception of the console logs stops. Moreover, when receiving the reset signal without receiving the console logs, the information processing apparatus 9 is restarted, and the console logs when started up are output.

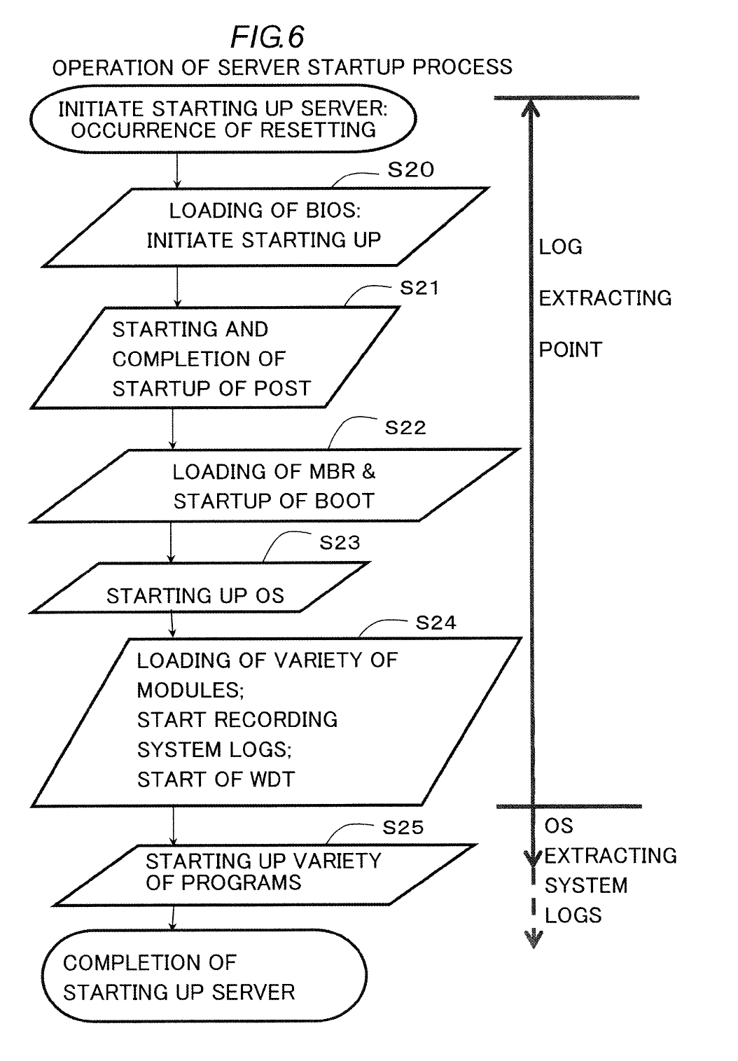

FIG. 6 illustrates a processing flow when starting up the server. A start of the processes in FIG. 6 is triggered by, e.g., the user's performing an operation of starting up the server. With the server startup operation, at first, the BIOS is loaded (S20). Next, Power On Self-Test (POST) is initiated and then completed (S21). Subsequently, Master Boot Record (MRB) is loaded, and further Boot loader is started up (S22). Next, the OS initiates the startup (S23).

Next, the variety of hardware modules of peripheral devices etc and drivers etc for driving the hardware modules initiate being started up (S24). Note that in the course of the process in step S24, the OS starts acquiring and saving the system logs. Further, the WDT 2 is started up. Next, the variety of computer programs initiate being started up (S25). Herein, from S24 onward, the OS records the system logs. Accordingly, even when the abnormality occurs from the process in S24 onward, a state of the occurrence of the abnormality has a possibility of its being recorded in the system log. On the other hand, the console logs are output for an interval between S20 and S24.

The processes of the example 1 enable, when the abnormality occurs for the interval between S20 and S24, the console logs generated at the occurrence of the abnormality to be saved. The information processing apparatus 9 therefore executes the following processes.

(A) The information processing apparatus 9 determines whether or not it reaches third predetermined time T3 after the resetting has been done when starting up the information processing apparatus 9.
(B) The information processing apparatus 9 detects whether the data are received or not and whether the received data fluctuate or not before reaching the third predetermined time T3. Then, if the status that the data are not received and the status that the received data do not fluctuate continue for the first predetermined time T1, the control unit 112 changes over the changeover switch 12. For instance, the changeover switch 12 changes over the connecting destination of the console data receiving unit 11 to the buffer 13-1 from the buffer 13-0. As a result, if the console logs are not received for the first predetermined time T1 or longer for the interval between S20 and S24, the already received console logs can be saved in the buffer 13-0 before the changeover made by the changeover switch 12 before being disabled from receiving the console logs.

Moreover, the control unit 112, when receiving the pre-timeout signal from the WDT 2, supplies the changeover trigger to the changeover switch 12. In this case, the console logs generated before receiving the pre-timeout signal from the WDT 2 are saved in one buffer, e.g., the buffer 13-0, while the console logs generated after receiving the pre-timeout signal from the WDT 2 are saved in another buffer, e.g., the buffer 13-1.

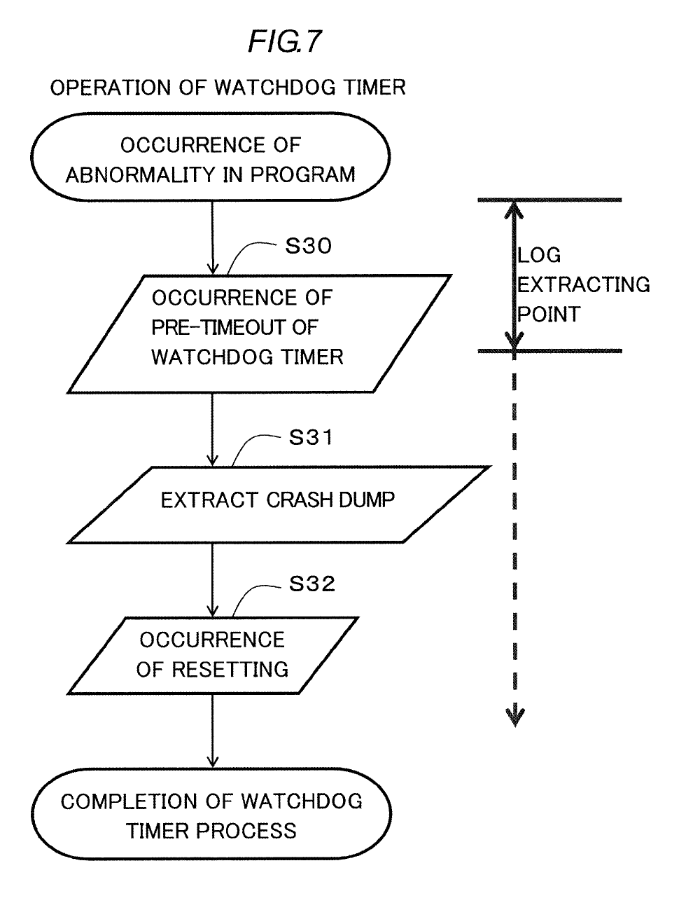

FIG. 7 is a diagram illustrating a processing flow for the WDT 2 to detect the occurrence of the abnormality of the program. If the abnormality occurs in the program in the execution underway on the information processing apparatus 9 with the result that the information processing apparatus 9 gets frozen, the WDT 2 issues the pre-timeout (S30). In the meantime, for example, the console logs are accumulated in the buffer 13-0. Then, the WDT 2 notifies the OS of the pre-timeout. The OS outputs a crash dump to the console log (S31). Note that the crash dump is recorded also in the system log of the OS. Thereafter, the information processing apparatus 9 is reset by the user's operation or by the exceptional process etc of the information processing apparatus 9 (S32) and then restarted.

In the processes of the example 1, with the pre-timeout given by the WDT 2, the changeover switch 12 changes over the connecting destination of the console data receiving unit 11 to the buffer 13-1 from the buffer 13-0. The changeover described above enables the console logs generated before and after the occurrence of the abnormality to be saved in the buffer 13-0.

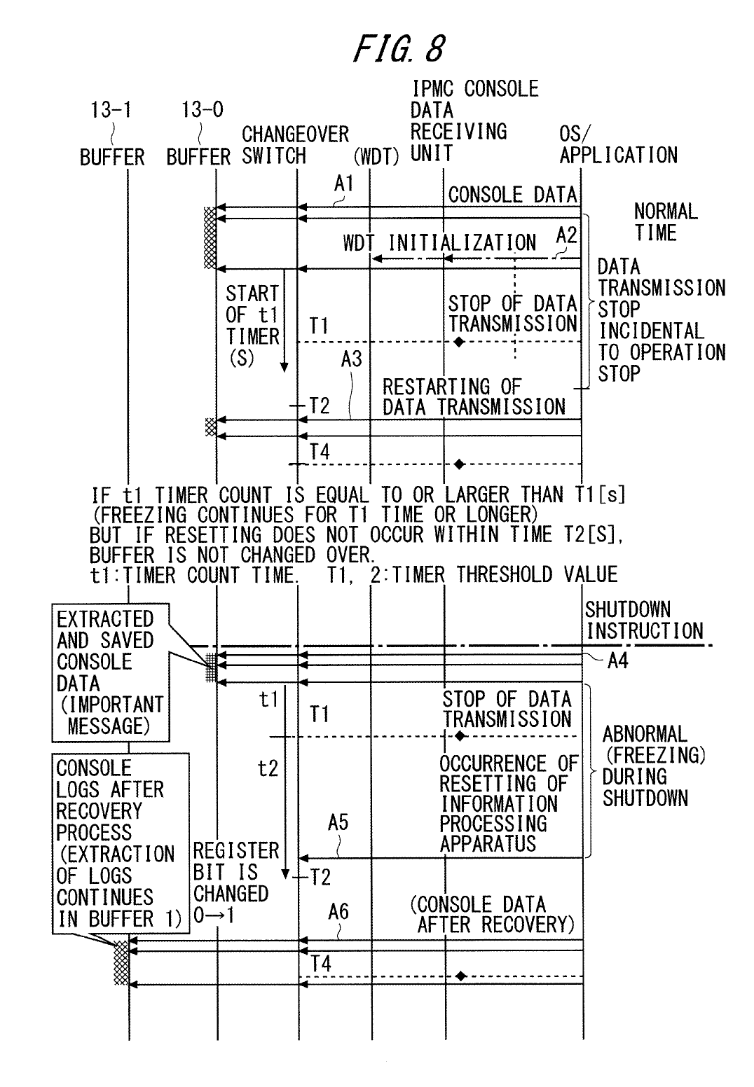

FIG. 8 depicts a comparison between a sequence of the normal operation and a sequence in the case of the occurrence of the abnormality when being shut down. In FIG. 8, the axis of ordinate corresponds to a time-base. Further, the components of the information processing apparatus 9, i.e., the buffers 13-0, 13-1, the changeover switch 12, the WDT 2, the console data receiving unit 11 of the IPMC 1 and the OS and the application programs executed by the CPU of the chipset 3 are illustrated in a direction of the axis of abscissa in FIG. 8. Moreover, FIG. 8 depicts the two sequences divided as an upper sequence and a lower sequence.

The upper sequence in FIG. 8 indicates the sequence at the normal time, e.g., when the information processing apparatus 9 is in the operation underway. In the normal operation status, the console logs are output from the OS or the application to the buffer 13-0 via the console data receiving unit 11 and the changeover switch 12 (arrow A1). Further, the timer initialization signal is transmitted from the OS to the WDT 2 (arrow A2).

Then, for instance, when the control unit 112 of the console data receiving unit 11 detects that the data are not received or that the received data do not fluctuate, the timer starts counting the time t1. Subsequently, if the time t1 exceeds the first predetermined time T1, the control unit 112 determines the non-reception status of the data or the non-fluctuation status of the received data. An expression of determining the non-reception status of the data or the non-fluctuation status of the received data is referred to as determining a disconnected status. In FIG. 8, however, the resetting of the information processing apparatus 9 does not occur after the time t1 counted by the timer 113 has gone with an elapse of the first predetermined time T1 but before the time t1 elapses by a duration of the second predetermined time T2. If having no occurrence of the resetting of the information processing apparatus 9 before the elapse of the second predetermined time T2, the control unit 112 sets again the timer 113 and restarts counting the time t1 from the time 0. Then, the control unit 112 determines again the disconnected status due to the elapse of the first predetermined time T1, and monitors if the resetting occurs before the elapse of the second predetermined time T2.

Then, in the upper sequence in FIG. 8, the disconnected status is cancelled after the elapse of the second predetermined time T2, and the data transmission is restarted. As a result, the control unit 112 restarts receiving the data (arrow A3), and the information processing apparatus 9 returns to the normal operation status.

The lower sequence in FIG. 8 indicates a sequence in a case where an error occurs when being shut down. In the lower sequence in FIG. 8, the console logs are output from the OS by inputting an instruction of the shutdown, e.g., the shutdown command and then recorded in the buffer 13-0 via the console data receiving unit 11 and the changeover switch 12 (arrow A4). Herein, an assumption is that during the execution of the shutdown, the information processing apparatus 9 gets frozen due to the abnormality in the information processing apparatus 9, with the result that the data transmission stops. When the data transmission stops, the timer 113 is started up, and, if the time t1 exceeds the first predetermined time T1, the control unit 112 determines the disconnected status. Thereupon, the control unit 112 further initializes the timer 113, and the timer 113 counts the time t2.

Then, if the resetting occurs (arrow A5) before the time t2 elapses by the duration of the second predetermined time T2, the control unit 112 changes over the changeover switch 12. Then, the changeover switch 12 changes over the connecting destination of the console data receiving unit 11 to the buffer 13-1 from the buffer 13-0. Namely, the control unit 112 changes the register bit of the changeover switch 12 to “1” from “0”. As a result, in the lower sequence in FIG. 8, the console logs generated immediately before occurrence of a freezing status during the shutdown can be retained in the buffer 13-0. Further, after the information processing apparatus 9 has been reset, the console logs after the recovery process are output to the buffer 13-1 (arrow A6).

Note that if the resetting occurs before the elapse of the first predetermined time T1 after starting again counting the time t1, such a possibility exists that the information processing apparatus 9 shifts to the status when started up, while the control unit 112 does not change over the changeover switch 12. However, the first predetermined time T1 is set by far shorter than the second predetermined time T2, thereby enabling such a possibility to be enhanced that the disconnected status can be determined and there can be executed the changeover between the buffer 13-0 and the buffer 13-1 due to detecting the occurrence of the resetting before the elapse of the second predetermined time T2.

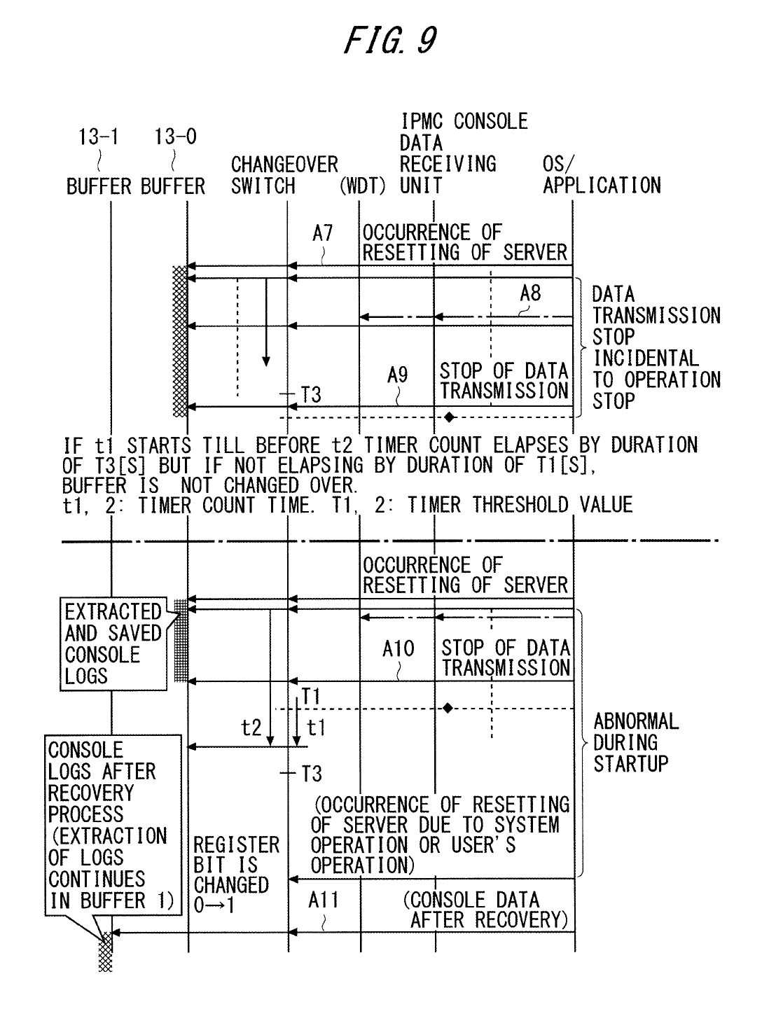

FIG. 9 illustrates sequences after the resetting due to starting up the information processing apparatus 9. An upper sequence in FIG. 9 is exemplified as a sequence in the normal status of not having any abnormality in the information processing apparatus 9. To be specific, after resetting the information processing apparatus 9, the console logs are output from the OS or the application and further output to the buffer 13-0 via the console data receiving unit 11 and the changeover switch 12 (arrow A7). Moreover, the WDT 2 is started up, and the OS starts transmitting the timer initialization signal to the WDT 2 (arrow A8). Then, the console logs coming from the OS or the application are stopped, for example, at the elapse of the third predetermined time T3 (arrow A9). A reason why the console logs are stopped is that after resetting the information processing apparatus 9, the predetermined startup process is completed for about the third predetermined time T3. From the third predetermined time T3 onward, the information processing apparatus 9 comes to the normal operation status and stands by for, e.g., an instruction from the user.

On the other hand, a lower sequence in FIG. 9 is exemplified as a sequence in an abnormality occurrence status when starting up the information processing apparatus 9. In the lower sequence in FIG. 9, after resetting the information processing apparatus 9, the data transmission of the console logs stops before the elapse of the third predetermined time T3 (arrow A10). The arrow A10 indicates the transmission of the console logs before stopping the data transmission.

Upon stopping the data transmission of the console logs, the data reception status detecting unit 111 notifies the control unit 112 that the data reception of the console logs is stopped. Thereupon, the control unit 112 controls the timer 113 to start counting the time t1. Then, during a reception stop period of the data of the console logs, i.e., when the time t1 elapses by the duration of the first predetermined time T1, the control unit 11 decides that the disconnected status is determined. Then, the control unit 112 changes over the changeover switch 12. Thereupon, the changeover switch 12 changes over the connecting destination of the console data receiving unit 11 to the buffer 13-1 from the buffer 13-0. Namely, the control unit 112 changes the register bit of the changeover switch 12 to “1” from “0”. Thereafter, the exceptional process of the information processing apparatus 9 is executed, or alternatively the user operates to reset the information processing apparatus 9. The console logs after the recovery process due to the resetting are output to the buffer 13-1 (arrow A11).

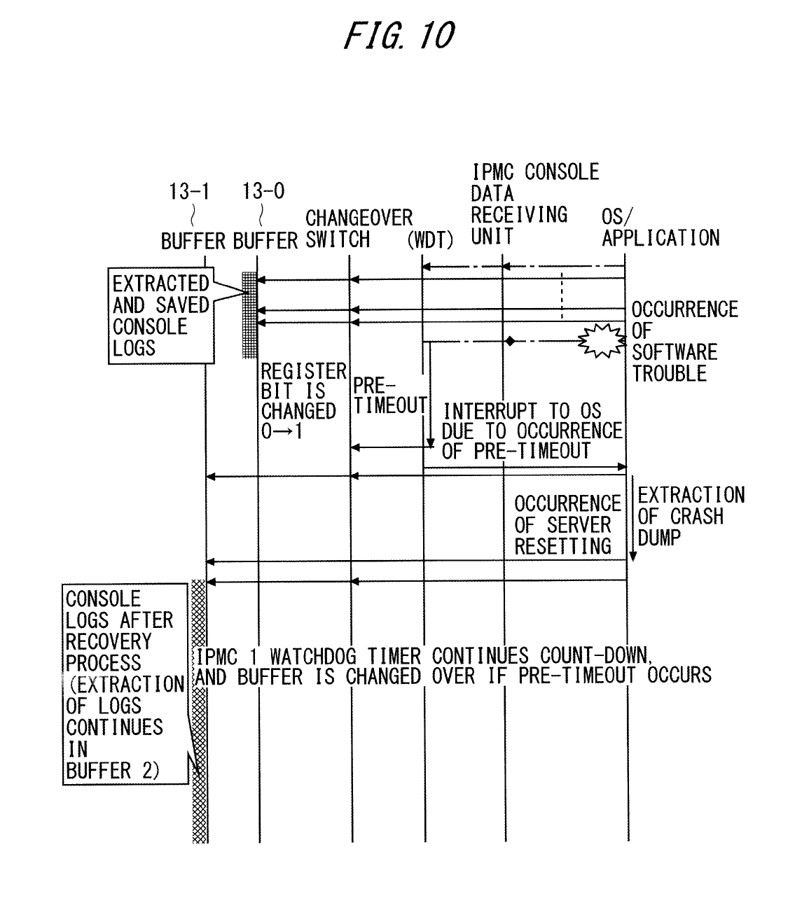

FIG. 10 illustrates a sequence in a case where the WDT 2 detects the freezing status of the OS or the application. If the application in the execution underway on the OS or the information processing apparatus 9 gets frozen, as explained in FIG. 3, for instance, the pre-timeout of the WDT 2 occurs. The WDT 2 notifies the control unit 112 of the occurrence of the pre-timeout. Thereupon, the control unit 112 changes the register bit of the changeover switch 12 to “1” from “0”. As a result, the changeover switch 12 changes over the connecting destination of the console data receiving unit 11 to the buffer 13-1 from the buffer 13-0.

Further, with the pre-timeout, the WDT 2 applies an interrupt to the OS. Then, the OS outputs the crash dump and resets the information processing apparatus 9. Accordingly, the crash dump and the console logs generated after the recovery due to resetting the information processing apparatus 9 are output to the buffer 13-1. As a result, the console logs immediately before the OS or the application gets frozen are retained in the buffer 13-0. If the OS is disabled due to a fault from resetting the information processing apparatus 9, the WDT 2 issues the timeout which is a further critical level just after the pre-timeout. The WDT 2, when issuing the timeout, resets the information processing apparatus 9 in a way that acts as a proxy for the OS. As a result of the resetting by the WDT 2, the information processing apparatus 9 is restarted and starts the recovery process.

<Processing Flow>

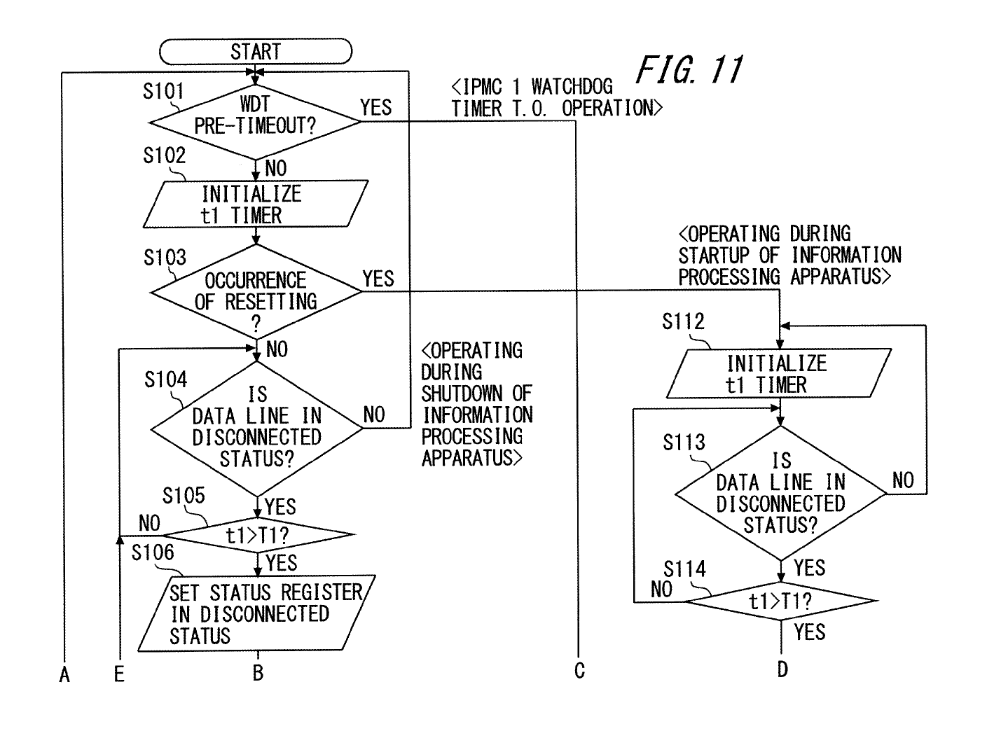

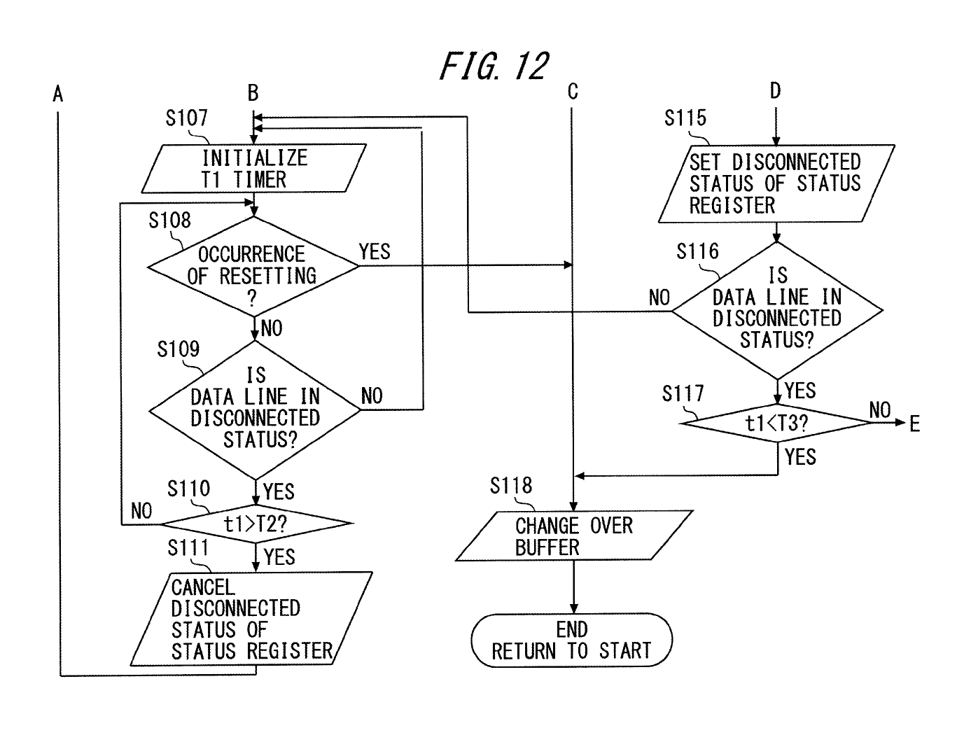

FIGS. 11 and 12 illustrate a processing flow of the control unit 112 of the IPMC 1. The CPU of the IPMC 1 loads the firmware, the computer programs, etc on the ROM into the main storage device, thereby functioning as the control unit 112. Note that the processes from “Start” onward in FIG. 11 represent completing the startup and following normal operations of the information processing apparatus 9.

In the normal operation status of the information processing apparatus 9, the control unit 112 checks the pre-timeout issued from the WDT 2 (S101). Then, if there is notification of the pre-timeout from the WDT 2, the control unit 112 advances the control to S118. The control unit 112 executes the processes in S101 and S118 by way of a control unit to change over the buffer becoming a storage destination of the log information according to the trigger signal.

The WDT 2 may, however, notify the control unit 112 of the pre-timeout through the interrupt. In the case of the interrupt-based notification, the control unit 112 may, if the interrupt occurs, execute the process in S118 of FIG. 12 without checking the pre-timeout in S101. A meaning of “if the interrupt occurs” is that, e.g., an interrupt handler started up when the interrupt occurs advances the control of the control unit 112 to S118.

Whereas if there is no notification of the pre-timeout from the WDT 2, the control unit 112 initializes the timer 113 for counting the time t1 (S102). Then, the control unit 112 determines whether the resetting occurs or not (S103). The control unit 112 executes a process in S103 by way of one example of a unit to detect that the information processing unit is reset.

Herein, the “resetting” is, e.g., an initializing command issued from the CPU of the chipset 3 when starting up the information processing apparatus 9. If the resetting occurs, the control unit 112 advances the control to S112. From S112 onward, there is executed the process when the resetting occurs, i.e., the process when starting up the information processing apparatus 9.

Moreover, if the resetting is determined not to occur in S103, the control unit 112 determines whether a data line extending from the chipset 3 is in the disconnected status or not (S104). The data reception status detecting unit 111 in FIG. 4 notifies the control unit 112 of a result as to whether in the disconnected status or not. Then, if the data line is not in the disconnected status, the control unit 112 loops back the control to S101.

Whereas if the data line is in the disconnected status, the control unit 112 determines whether the time t1 counted by the timer 113 elapses by a duration of a first initial value T1 or not (S105). Then, if the time t1 counted by the timer 113 does not elapse by the duration of the first initial value T1, the control unit 112 loops back the control to S104, and checks again the disconnected status of the data line. In the processes of S104-S105, if the disconnected status continues for the first predetermined time or longer, the control unit 112 recognizes the disconnected status. The control unit 112 executes the processes in S104 and S105 by way of one example of a unit to detect whether a period, for which the log information is not output, elapses by a duration of predetermined time or not.

Further, if it is determined in S105 that the time t1 counted by the timer 113 elapses by the duration of the first initial value T1, the control unit 112 sets a status register within the control unit 112 in the disconnected status (S106). Then, the control unit 112 advances the control to S107 in FIG. 12. Subsequently, the control unit 112 applies the initial setting to the timer 113 for counting the time t1 (S107).

Next, the control unit 112 monitors if the resetting occurs (S108). The control unit 112 executes a process in S108 by way of one example of a unit to detect that the information processing unit is reset. Then, if the resetting does not occur, the control unit 112 determines whether the data line is in the disconnected status or not (S109). Then, when the data line is not in the non-disconnected status, i.e., when receiving the console logs from the chipset 3, the control unit 112 loops back the control to S107.

Furthermore, if it is determined S109 that the data line is in the disconnected status, the control unit 112 determines whether or not the time t1 counted by the timer 113 elapses by a duration of a second initial value T2 (S110). Then, if the time t1 does not elapse by the duration of the second initial value T2, the control unit 112 loops back the control to S108, and monitors if the resetting occurs. Whereas if the time t1 elapses by the duration of the second initial value T2, the control unit 112 cancels the disconnected status of the status register (S111). Subsequently, the control unit 112 loops back the control to S101. Namely, if the time t1 elapses by the duration of the second initial value T2 without any occurrence of the resetting, the control unit 112 repeats the processes from S101, i.e., from the beginning.

Moreover, if it is determined in S108 that the occurrence of the resetting is confirmed, the control unit 112 controls the changeover switch 12 to change over the connecting destination between the buffer 13-0 and the buffer 13-1 (S118). To be specific, the connecting destination of the console data receiving unit 11 is changed over between the buffer 13-0 and the buffer 13-1. The control unit 112 executes, when the resetting is detected before the predetermined or more quantity of log information is output, the processes in S108 and S118 by way of a control unit to change over the buffer becoming a storage destination of the log information.

Further, if it is determined in S103 of FIG. 11 that the occurrence of the resetting is confirmed, the information processing apparatus 9 executes the processes from S112 onward during the startup of the information processing apparatus 9. Namely, the control unit 112 applies the initial setting to the timer 113 for counting the time t1 (S112). Then, the control unit 112 determines whether the data line is in the disconnected status or not (S113). Subsequently, if the data line is not in the disconnected status, the control unit 112 loops back the control to S112. Accordingly, after the occurrence of the resetting, as far as the data line does not get into the disconnected status, the initialization of the time t1 is implemented at a predetermined time interval. However, after the information processing apparatus 9 has been reset and after the predetermined quantity of console logs have been output, the information processing apparatus 9 comes to the normal operation status, at which time the output of the console logs ceases.

That is, if it is determined in S113 that the data line comes to the disconnected status, next the control unit 112 determines whether the time t1 elapses by the duration of the first predetermined time T1 or not (S114). Then, if the time t1 does not elapse by the duration of the first predetermined time T1, the control unit 112 loops back the control to S113, and checks whether the data line is in the disconnected status or not (S113). In the processes in S113-S114, if the disconnected status continues for the first predetermined time or longer, the control unit 112 recognizes this disconnected status.

Then, if it is determined in S114 that the time t1 elapses by the duration of the first predetermined time T1, the control unit 112 sets the status register in the disconnected status (S115). Next, the control unit 112 checks whether the data line is in the disconnected status or not (S116). Subsequently, if the data line is not in the disconnected status, the control unit 112 advances the control to S107. Then, the control unit 112 stands by for the operation in the case of being instructed to shut down during the normal operation from S107 onward.

Whereas if it is determined in S116 that the data line is in the disconnected status, the control unit 112 determines whether the time t1 elapses by the duration of the third predetermined time T3 or not (S117). Then, if the time t1 elapses by the duration of the third predetermined time T3, the control unit 112 advances the control to S104, and checks whether the data line is in the disconnected status or not. If the time t1 elapses by the duration of the third predetermined time T3, it may be considered that the output of the console logs after being reset is completed. Accordingly, the control unit 112 checks whether the data line is in the disconnected status or not in a normal operating status.

Moreover, it is determined in S117 that the time t1 does not elapse by the duration of the third predetermined time T3, the control unit 112 advances the control to S118, and changes over the buffer. This is because if it is determined in S117 that the time t1 does not elapse by the duration of the third predetermined time T3, after the occurrence of the resetting but before outputting the console logs which are to be originally output, the data line has come to the disconnected status, and the duration of the disconnected status has been determined to reach the first predetermined time T1. The control unit 112 executes the processes in S117 and S118 by way of a unit to change over the storage destination of the log information when the predetermined or more quantity of log information is not output before the elapse of the predetermined period after detecting the resetting.

As discussed above, according to the information processing apparatus 9 of the example 1, the control unit 112 confirms that the disconnected status of the console logs to the data port of the IPMC 1 from the chipset 3 via the data line continues for the first predetermined time T1 or longer. Then, after confirming the disconnected status, the control unit 112 monitors if the resetting of the information processing apparatus 9 occurs and, if the resetting occurs, controls the changeover switch 12 to change over the output destination of the console data receiving unit 11 to, e.g., the buffer 13-1 from the buffer 13-0. Accordingly, before coming to the disconnected status, the console logs being output to the buffer 13-0 can be retained in the buffer 13-0, while the console logs after the resetting has been done can be accumulated in the buffer 13-1. Through these processes, after becoming the disconnected status, the information processing apparatus 9 is reset by the exceptional process of the information processing apparatus 9 or by the user's operation, and the recovery process is carried out, in which case also the console logs before becoming the disconnected status, i.e., the console logs when the fault occurs can be saved.

Furthermore, the control unit 112 continues to monitor the resetting after confirming the disconnected status up to the second predetermined time T2 and, after the elapse of the second predetermined time T2, checks again whether the disconnected status continues for the first predetermined time T1 or not. Accordingly, during the operation of the information processing apparatus 9, if the console logs get consecutive for the first predetermined time T1 or longer and are thereafter output, the changeover between the buffer 13-0 and the buffer 13-1 can be restrained. A reason why to restrain the changeover between the buffers is that the console logs in the normal and general processes may not be saved by changing over the plurality of buffers. Namely, according to the information processing apparatus 9, it is feasible to store effectively and separately the logs generated when the fault occurs, which are originally desired to be acquired, and the logs in the recovery process from the occurrence of the fault onward.

Moreover, according to the information processing apparatus 9, after starting up the information processing apparatus 9 but before the elapse of the third predetermined time T3, it is checked whether or not the disconnected status of the console logs continues for the first predetermined time T1 or longer. Then, if the disconnected status of the console logs continues for the first predetermined time T1 or longer, the control unit 112 confirms this disconnected status. Subsequently, after confirming the disconnected status, the control unit 112 controls the changeover switch 12 to change over the output destination of the console data receiving unit 11 to, e.g., the buffer 13-1 from the buffer 13-0.

With the changeover from the buffer 13-0 to the buffer 13-1 as described above, it is possible to perform the recovery process from the disconnected status at the time of the resetting in the wake of the startup of the information processing apparatus 9, i.e., it is possible to, for example, even when the resetting is done, save the console logs generated when the fault occurs after being started up in, e.g., the buffer 13-0 and output the console logs incidental to the recovery process to the buffer 13-1. The information processing apparatus 9 can therefore retain the console logs being output to the buffer 13-0 before coming to the disconnected status as they are.

Furthermore, after the elapse of the third predetermined time T3, the control unit 112 shifts to the process of confirming the disconnected status of the console logs when in the normal operation. This is because it can be considered that after the elapse of the third predetermined time T3, the console logs at the time of the resetting incidental to the startup of the information processing apparatus 9 will have been normally output.

However, irrespective of whether the third predetermined time T3 elapses or not, the disconnected status may also be checked. In this case, the disconnected status monitoring process when being shut down and the disconnected status monitoring process when being started up can be executed through the same process.

Moreover, according to the information processing apparatus 9, the control unit 112 controls the WDT 2 to monitor if the information processing apparatus 9 gets frozen due to the OS or the application program or monitor if the console logs are in the disconnected status. Then, upon notification from the WDT 2, the control unit 112 controls the changeover switch 12 to change over the output destination of the console data receiving unit 11 to, e.g., the buffer 13-1 from the buffer 13-0. Hence, according to the information processing apparatus 9, the recovery process from the disconnected status can be done, i.e., the console logs incidental to the resetting of the information processing apparatus 9 are output to the buffer 13-1, and therefore it is possible to retain the console logs being output to the buffer 13-0 as they are before getting into the disconnected status.

### Second Working Example

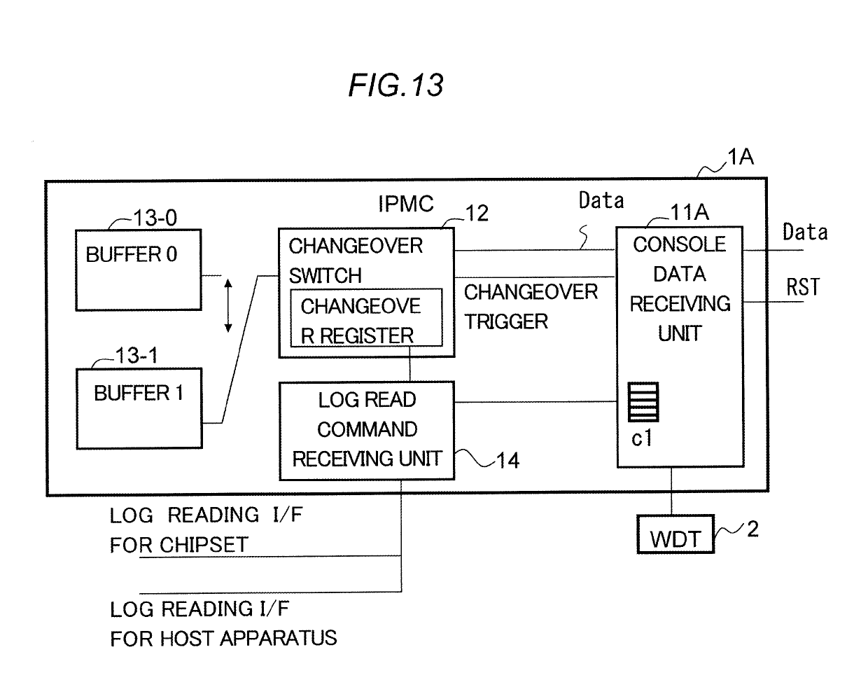

The information processing apparatus 9 according to a second working example (Example 2) will be described with reference to FIGS. 13-16. In the example 1, the disconnected status etc of the console logs is checked based on the time counted by the timer 113, the WDT 2, etc via the data line extending to the data port of the IPMC 1 from the chipset 3. In the example 2, the disconnected status is checked based on, in place of the time, a data quantity (data size), e.g., a data transfer quantity per unit time, of the console logs via the data line extending to the data port of the IPMC 1 from the chipset 3. With respect to the processes other than a point of checking the disconnected status etc on the basis of the data size of the console logs, components in the second embodiment (example 2) are the same as the components in the first embodiment (example 1). Such being the case, the same components as the components in the first embodiment are marked with the same symbols and numerals, and the redundant explanations thereof are omitted. For example, the configuration of the information processing apparatus 9 is the same as the configuration in FIG. 1, and hence the description thereof is omitted. In the example 2, however, the information processing apparatus 9 includes an IPMC 1A in place of the IPMC 1.

FIG. 13 depicts a configuration of the IPMC 1A according to the example 2. As in FIG. 13, the IPMC 1A is different from the IPMC 1 in FIG. 2 in the example 1 in terms of including a console data receiving unit 11A as a substitute for the console data receiving unit 11.

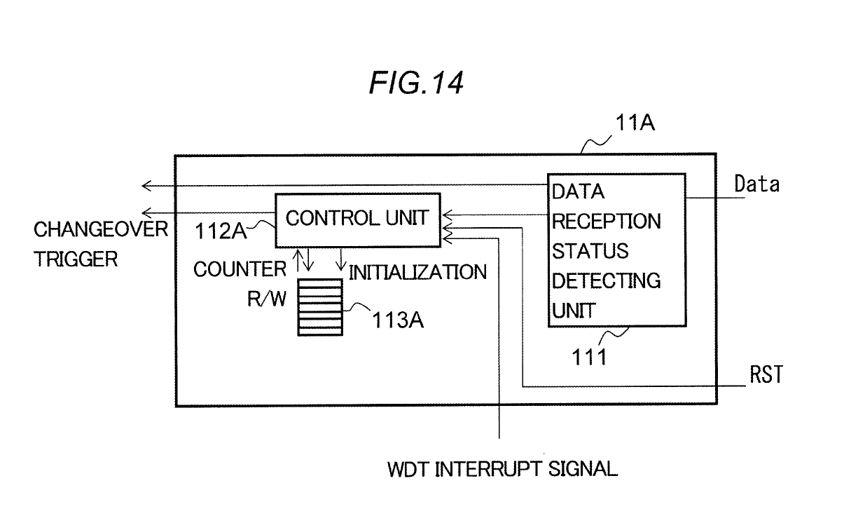

FIG. 14 illustrates a configuration of the console data receiving unit 11A according to the example 2. As in FIG. 14, the console data receiving unit 11A is different from the console data receiving unit 11 in the example 1 in terms of a point of including a control unit 112A and a counter 113A in place of the control unit 112 and the timer 113. To be specific, the console data receiving unit 11A checks and cancels the disconnected status in such a way that the counter 113A monitors the data size of the reception data flowing to the data port from the chipset 3 via the data line instead of the timer 113 counting the time.

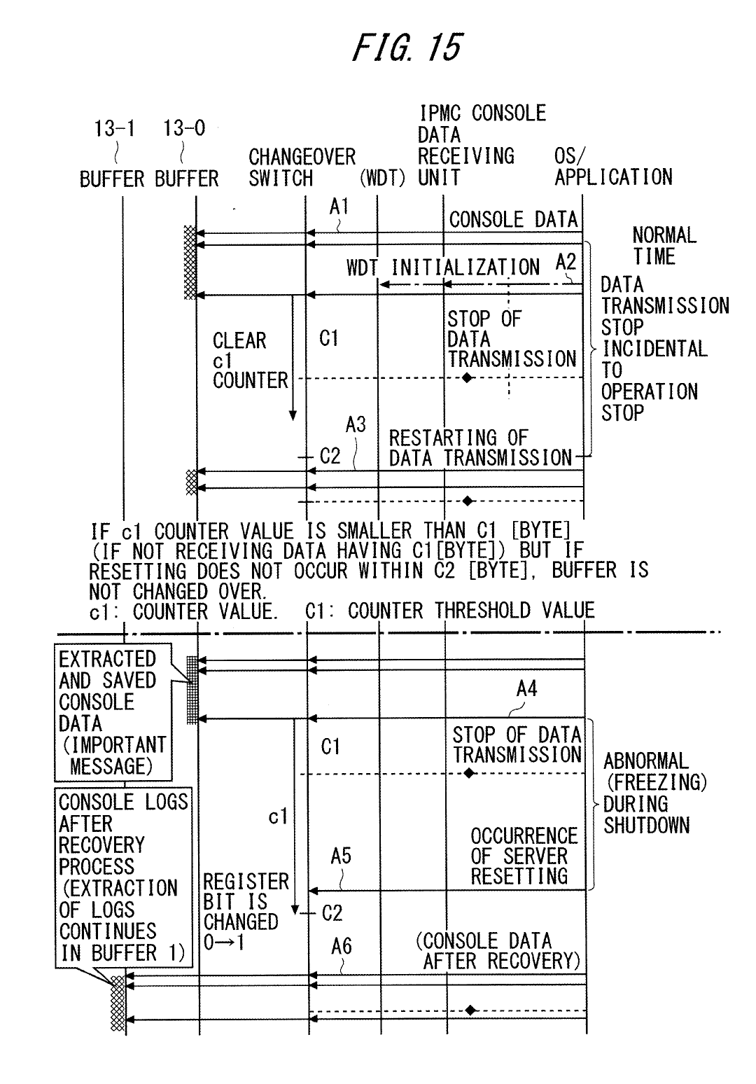

FIG. 15 illustrates a comparison between the sequence of the normal operation and the sequence a sequence in the case of the occurrence of the abnormality when being shut down. In FIG. 15 also, similarly to FIG. 8 in the example 1, the console logs are output from the OS or the application and further output to the buffer 13-0 via the console data receiving unit 11A and the changeover switch 12 (arrow A1). Further, the timer initialization signal is transmitted from the OS to the WDT 2 (arrow A2).

In the example 2, however, e.g., when the control unit 112A of the console data receiving unit 11A detects that the data are not received or that the received data do not fluctuate, the control unit 112A clears the counter 113A. Then, the control unit 112A, after clearing the counter 113A, counts a reception byte count of the console logs. Subsequently, the control unit 112A determines whether the reception byte count is a count smaller than a first reference byte count C1 or not. The control unit 112A, when the reception byte count after clearing the counter 113A is smaller than C1 bytes, determines that the disconnected status of the console logs via the data line extending from the chipset 3 continues.

Thereafter, if the reception byte count increases and reaches C2 bytes, the control unit 112A does not execute the changeover between the buffer 13-0 and the buffer 13-1. It is because the status can be determined to be the normal operation status. That is, in an upper sequence in FIG. 15, after receiving the C2 bytes or more, the disconnected status is cancelled, and the data transmission is restarted. As a result, the control unit 112A restarts receiving the data (arrow A3), while the information processing apparatus 9 returns to the normal operation status.

A lower sequence in FIG. 15 indicates a sequence in a case where an error is caused when being shut down. In the lower sequence in FIG. 15, the console logs are output from the OS by inputting an instruction to shut down, e.g., a shutdown command and further output to the buffer 13-0 via the console data receiving unit 11A and the changeover switch 12 (arrow A4). Then, similarly to FIG. 8 in the example 1, such a case is assumed that the information processing apparatus 9 gets frozen due to the abnormality of the information processing apparatus 9 during the execution of the shutdown with the result that the data transmission is stopped. Thereupon, the control unit 112A clears the counter 113A, and determines whether the reception byte count is smaller than the first reference byte count C1 or not.

Then, the control unit 112A continues to monitor if the resetting occurs till the reception byte count reaches a second reference byte count C2. Subsequently, if the resetting occurs before the reception byte count reaches the second reference byte count C2 (arrow A5), the control unit 112A changes over the changeover switch 12. Thereupon, the changeover switch 12 changes over the connecting destination of the console data receiving unit 11A to the buffer 13-1 from the buffer 13-0. Namely, the control unit 112A changes the register bit of the changeover switch 12 to “1” from “0”. As a result, in the lower sequence in FIG. 15, the buffer 13-0 can retain the console logs just before the freeze occurs during the shutdown. Further, after resetting the information processing apparatus 9, the console logs posterior to the recovery process are output to the buffer 13-1 (arrow A6).

In the discussion made above, the disconnected status is defined such that the reception byte count after clearing the counter 113A exists within a value range less than the first reference byte count C1, and the operation of monitoring if the resetting occurs continues to be done till the reception byte count reaches the second reference byte count C2. Such a determination as to the byte count may be made based on the reception byte count per short time. To be specific, when the control unit 112A detects that the data are not received or that the received data do not fluctuate, it may be determined whether or not the reception byte count per unit time is smaller than the first reference byte count C1, and the continuation of the disconnected status may be thus checked. Further, the control unit 112A may also, after checking the continuation of the disconnected status, monitor if the resetting occurs till the reception byte count per unit time reaches the second reference byte count C2. Then, temporarily if the reception byte count per unit time reaches the second reference byte count C2, it may be again detected that the data are not received or that the received data do not fluctuate. Whereas if the reception byte count per unit time does not reach the second reference byte count C2, the monitoring of the occurrence of the resetting may continue.

As discussed above, with the checking of the reception byte count enables, in the same way as in the example 1, or more precisely than in the example 1, the determination as to the continuation of the disconnected status can be made. As a result, the console logs just before becoming the disconnected status are saved in, e.g., the buffer 13-0, and, when the resetting occurs in the disconnected status, the console logs after the recovery can be output to the buffer 13-1.

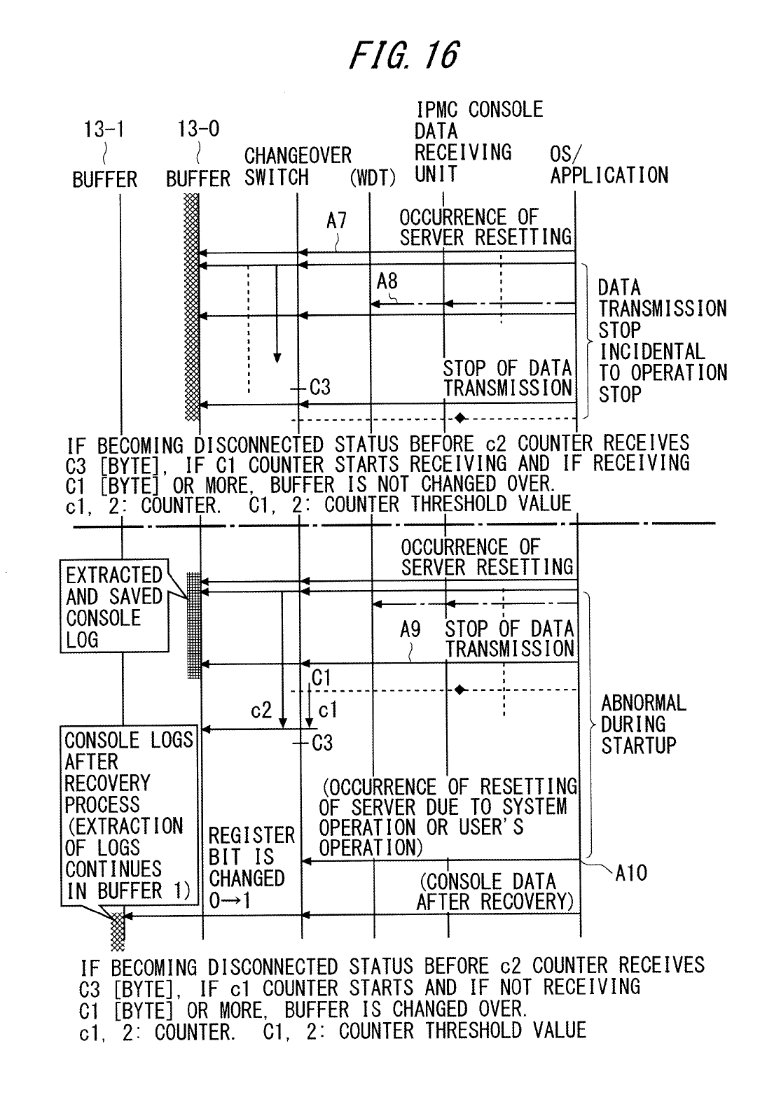

FIG. 16 depicts a comparison between the sequence of the normal operation and the sequence in the occurrence of the abnormality when started up. In the upper sequence in FIG. 16 also, similarly to FIG. 9 in the example 1, after resetting the information processing apparatus 9, the console logs are output from the OS or the application and further output to the buffer 13-0 via the console data receiving unit 11A and the changeover switch 12 (arrow A7). Further, the WDT 2 is started up, and the OS starts transmitting the timer initialization signal to the WDT 2 (arrow A8). Then, when the console logs, of which a log size is equal to or larger than a third predetermined reference byte count C3, are received from the OS or the application, the control unit 112A determines that the information processing apparatus 9 is normally started up. Therefore, the control unit 112A does not perform the changeover between the buffer 13-0 and the buffer 13-1.

On the other hand, a lower sequence in FIG. 9 indicates a sequence in the case of the occurrence of the abnormality when starting up the information processing apparatus 9. In the lower sequence in FIG. 9, after resetting the information processing apparatus 9 but before receiving the third predetermined reference byte count C3, the data transmission of the console logs stops (arrow A9). The arrow A9 represents the transmission of the console logs immediately before stopping the data transmission.

Namely, the control unit 112A, when detecting that the data are not received or that the received data do not fluctuate, clears the counter 113A. Then, the control unit 112A determines whether or not the reception byte count after clearing the counter 113A is a count less than the first reference byte count C1. The control unit 112A, if the reception byte count after clearing the counter 113A is the count less than the first reference byte count C1, decides that the disconnected status of the console logs via the data line from the chipset 3 is determined.

Thereupon, the control unit 112A changes over the changeover switch 12. Then, the changeover switch 12 changes over the connecting destination of the console data receiving unit 11A to the buffer 13-1 from the buffer 13-0. That is, the control unit 112A changes the register bit of the changeover switch 12 to “1” from “0”. Thereafter, the information processing apparatus 9 is reset by the exceptional process of the information processing apparatus 9 or by the user's operation. The console logs after the recovery process due to the resetting are output to the buffer 13-1 (arrow A10).

As discussed above, the counter 113A counts the reception byte count, thereby enabling the disconnected status of the console logs to be detected similarly to the example 1 or more precisely than in the example 1. Accordingly, the abnormality caused when starting up the information processing apparatus 9 is detected, the console logs just before becoming the disconnected status are saved in, e.g., the buffer 13-0, and the console logs when being reset in the disconnected status and after the recovery from the abnormality can be output to the buffer 13-1.

Note that in the processes of FIG. 16 also, the determination based on the first reference byte count C1 or the third reference byte count C3 may be made in comparison with the reception byte count per unit time, and the continuation of the disconnected status or the normal termination of the startup process may also be determined.

<Non-Transitory Computer-Readable Recording Medium>

A program for making a computer exemplified by the IPMC 1, other machines and apparatuses (which will hereinafter be referred to as the computer etc) realize any one of the functions can be recorded on a non-transitory recording medium readable by the computer etc. Then, the computer etc is made to read and execute the program on this non-transitory recording medium, whereby the function thereof can be provided.

Herein, the non-transitory recording medium readable by the computer etc connotes a non-transitory recording medium capable of accumulating information such as data and programs electrically, magnetically, optically, mechanically or by chemical action, which can be read from the computer etc. Among these non-transitory recording mediums, for example, a flexible disc, a magneto-optic disc, a CD-ROM, a CD-R/W, a DVD, a Blu-ray disc, a DAT, an 8 mm tape, a memory card such as a flash memory, etc are given as those removable from the computer etc. Further, a hard disc, a ROM (Read-Only Memory), etc are given as the non-transitory recording mediums fixed within the computer etc.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
an information processing unit;
a unit to detect that the information processing unit is reset;
an acquiring unit to acquire log information of the information processing unit;
a plurality of buffers to store the log information acquired by the acquiring unit; and
a control unit to change over the buffer becoming a storage destination of the log information acquired by the acquiring unit when a relation of a time point of resetting the information processing unit and an acquired quantity of the log information satisfies a condition.

2. The information processing apparatus according to claim 1, wherein the control unit includes:
a unit to detect whether a period, for which the log information is not output, elapses by a duration of predetermined time or not; and
a unit to, when the period for which the log information is not output elapses by the duration of predetermined time and the resetting is detected before the log information is output, change over the storage destination of the log information.

3. The information processing apparatus according to claim 1, wherein the control unit includes a unit to, when a predetermined quantity of the log information is not output before a predetermined period elapses since after detecting the resetting, change over the storage destination of the log information.

4. The information processing apparatus according to claim 1, further comprising a trigger signal generating unit to receive a timer initialization signal at a predetermined cycle from the information processing unit and to generate, when disabled from receiving the timer initialization signal within the predetermined cycle, a trigger signal indicating that time of the predetermined cycle elapses,
wherein the control unit includes a unit to change over the storage destination of the log information in accordance with the trigger signal.

5. An information processing method by which a computer executes:
detecting that an information processing unit is reset;
acquiring log information of the information processing unit;
storing the acquired log information in any one of a plurality of buffers; and
changing over the buffer becoming a storage destination of the log information acquired when a relation of a time point of resetting the information processing unit and an acquired quantity of the log information satisfies a condition.

6. The information processing method according to claim 5, wherein the changing over the buffer includes:
detecting whether a period, for which the log information is not output, elapses by a duration of predetermined time or not; and
changing over, when the period for which the log information is not output elapses by the duration of predetermined time and the resetting is detected before the log information is output, the storage destination of the log information.

7. The information processing method according to claim 5, wherein the changing over the buffer includes changing over, when the log information is not output before a predetermined period elapses since after detecting the resetting, the storage destination of the log information.

8. The information processing method according to claim 5, wherein the changing over the buffer includes;
receiving a timer initialization signal at a predetermined cycle from the information processing unit and generating, when disabled from receiving the timer initialization signal within the predetermined cycle, a trigger signal indicating that time of the predetermined cycle elapses: and
changing over the storage destination of the log information in accordance with the trigger signal.

9. A computer-readable storage medium to store a program to cause a computer to execute:
detecting that an information processing unit is reset;
acquiring log information of the information processing unit;
storing the acquired log information in any one of a plurality of buffers; and
changing over the buffer becoming a storage destination of the log information acquired when a relation of a time point of resetting the information processing unit and an acquired quantity of the log information satisfies a condition.

10. The computer-readable storage medium to store the program according to claim 9, wherein the changing over the buffer includes:
detecting whether a period, for which the log information is not output, elapses by a duration of predetermined time or not; and
changing over, when the period for which the log information is not output elapses by the duration of predetermined time and the resetting is detected before the log information is output, the storage destination of the log information.

11. The computer-readable storage medium to store the program according to claim 9, wherein the changing over the buffer includes changing over, when the log information is not output before a predetermined period elapses since after detecting the resetting, the storage destination of the log information.

12. The computer-readable storage medium to store the program according to claim 9, wherein the changing over the buffer includes;
receiving a timer initialization signal at a predetermined cycle from the information processing unit and generating, when disabled from receiving the timer initialization signal within the predetermined cycle, a trigger signal indicating that time of the predetermined cycle elapses: and
changing over the buffer becoming a storage destination of the log information in accordance with the trigger signal.
